(19) United States
(12) Patent Application Publication
(10) Pub. No.: US 2021/0315313 A1
(43) Pub. Date: Oct. 14, 2021

(54) MICROPHONE INTEGRATED INTO HELMET

(71) Applicant: Hamilton Sundstrand Corporation, Charlotte, NC (US)

(72) Inventor: Jake Rohrig, Simsbury, CT (US)

(21) Appl. No.: 17/223,633

(22) Filed: Apr. 6, 2021

Related U.S. Application Data
(60) Provisional application No. 63/006,959, filed on Apr. 8, 2020.

(51) Int. Cl. A42B 3/30; B64G 6/00; G01H 11/06

(52) U.S. Cl. CPC A42B 3/30; G01H 11/06; B64G 6/00

(57) ABSTRACT

A helmet with an integrated microphone includes a first portion to attach to a mating ring. The first portion is shaped to create a volume for a head of a wearer. The helmet also includes a second portion to attach to the mating ring. The first portion is entirely surrounded by the second portion without being in contact with the second portion and the second portion is farther from the volume than the first portion. One or more vibration sensors are attached to the first portion. The one or more vibration sensors output an electrical signal and the microphone is formed by the one or more vibration sensors and the first portion.

### CROSS-REFERENCE TO RELATED APPLICATIONS

This application claims the benefit of U.S. Provisional Application 63/006,959 filed Apr. 8, 2020, the disclosure of which is incorporated herein by reference in its entirety.

### BACKGROUND

Exemplary embodiments pertain to the art of communication and, in particular, to a microphone integrated into a helmet.

In certain environments, a helmet is used not only for protection but also to maintain a specific environment for the wearer. In a deep space application, for example, the helmet that is part of the extravehicular mobility unit (i.e., space suit) contains gases to sustain the wearer. In a prior extravehicular mobility unit, in addition to this helmet, the wearer also wears a communications carrier assembly (CCA). The CCA is a cap worn directly on the head of the wearer, akin to a skull cap with a chin strap.

### BRIEF DESCRIPTION

In one embodiment, a helmet with an integrated microphone includes a first portion configured to attach to a mating ring. The first portion is shaped to create a volume for a head of a wearer. The helmet also includes a second portion to attach to the mating ring. The first portion is entirely surrounded by the second portion without being in contact with the second portion and the second portion is farther from the volume than the first portion. One or more vibration sensors are attached to the first portion. The one or more vibration sensors output an electrical signal and the microphone is formed by the one or more vibration sensors and the first portion.

Additionally or alternatively, in this or other embodiments, the one or more vibration sensors are bonded to an outer surface of the first portion in a space between the first portion and the second portion.

Additionally or alternatively, in this or other embodiments, the helmet also includes processing circuitry to receive the electrical signal from each of the one or more vibration sensors.

Additionally or alternatively, in this or other embodiments, the processing circuitry provides an output signal to a radio frequency (RF) transmitter, and the RF transmitter transmits an RF signal resulting from the output signal of the processing circuitry.

Additionally or alternatively, in this or other embodiments, the one or more vibration sensors are transducers or piezoelectric (PE) sensors.

Additionally or alternatively, in this or other embodiments, the one or more vibration sensors is arranged on the first portion to sense vibration in the first portion and generate the electrical signal in response to the vibration.

Additionally or alternatively, in this or other embodiments, the first portion and the second portion include a polycarbonate layer.

In another embodiment, an atmospheric suit with a microphone integrated into a helmet includes a first portion of the helmet to attach to a mating ring of the atmospheric suit. The first portion of the helmet is shaped to create a volume for the head of a wearer and the first portion creates an internal atmosphere of the atmospheric suit when attached to the mating ring. A second portion of the helmet attaches to the mating ring. The first portion of the helmet is entirely surrounded by the second portion of the helmet without being in contact with the second portion of the helmet and the second portion of the helmet is farther from the volume than the first portion of the helmet. One or more vibration sensors are attached to the first portion of the helmet. The one or more vibration sensors are configured to output an electrical signal and the microphone is formed by the one or more vibration sensors and the first portion of the helmet.

Additionally or alternatively, in this or other embodiments, the one or more vibration sensors are bonded to an outer surface of the first portion of the helmet in a space between the first portion of the helmet and the second portion of the helmet, and the one or more vibration sensors are transducers or piezoelectric (PE) sensors.

Additionally or alternatively, in this or other embodiments, the atmospheric suit also includes processing circuitry to receive the electrical signal from each of the one or more vibration sensors.

Additionally or alternatively, in this or other embodiments, the processing circuitry provides an output signal to a radio frequency (RF) transmitter, and the RF transmitter transmits an RF signal resulting from the output signal of the processing circuitry.

Additionally or alternatively, in this or other embodiments, the one or more vibration sensors is arranged on the first portion of the helmet to sense vibration in the first portion of the helmet and generate the electrical signal in response to the vibration.

Additionally or alternatively, in this or other embodiments, the first portion of the helmet and the second portion of the helmet include a polycarbonate layer.

In yet another embodiment, a method of assembling a microphone includes attaching one or more vibration sensors to a first portion of a helmet. The one or more vibration sensors provide an electrical signal. The method also includes attaching the first portion of the helmet to a mating ring to create a volume for a head of a wearer of the helmet, and attaching a second portion of the helmet to the mating ring such that the first portion of the helmet is entirely surrounded by the second portion of the helmet without being in contact with the second portion of the helmet. The second portion of the helmet is farther from the volume than the first portion of the helmet.

Additionally or alternatively, in this or other embodiments, the attaching the one or more vibration sensors to the first portion of the helmet includes bonding the one or more vibration sensors to an outer surface of the first portion of the helmet in a space between the first portion of the helmet and the second portion of the helmet.

Additionally or alternatively, in this or other embodiments, the method also includes arranging processing circuitry to receive the electrical signal from each of the one or more vibration sensors.

Additionally or alternatively, in this or other embodiments, the method also includes configuring the processing circuitry to provide an output signal to a radio frequency (RF) transmitter and configuring the RF transmitter to transmit an RF signal resulting from the output signal of the processing circuitry.

Additionally or alternatively, in this or other embodiments, the attaching the one or more vibration sensors includes attaching one or more transducers or piezoelectric (PE) sensors.

Additionally or alternatively, in this or other embodiments, the attaching the one or more vibration sensors to the first portion of the helmet includes arranging the one or more vibration sensors to sense vibration in the first portion of the helmet and generate the electrical signal in response to the vibration.

Additionally or alternatively, in this or other embodiments, the first portion of the helmet and the second portion of the helmet include a polycarbonate layer.

### BRIEF DESCRIPTION OF THE DRAWINGS

The following descriptions should not be considered limiting in any way. With reference to the accompanying drawings, like elements are numbered alike:

FIG. 1 shows aspects of an atmospheric suit with a microphone integrated into a helmet according to one or more embodiments; and

FIG. 2 is an exploded view of a helmet with integrated microphones according to one or more embodiments.

### DETAILED DESCRIPTION

A detailed description of one or more embodiments of the disclosed apparatus and method are presented herein by way of exemplification and not limitation with reference to the Figures.

As previously noted, certain applications require a helmet that maintains an internal environment for the wearer in addition to providing protection. One example is a helmet of an extravehicular mobility unit (i.e., space suit). In addition to this helmet, a wearer also wears a CCA as a cap fastened to the head according to a prior approach. The CCA includes headphones and microphones to facilitate communication to and from the wearer of the extravehicular mobility unit. The CCA, which is directly on the wearer's head, is below the helmet and between the wearer and the helmet. Thus, once in the extravehicular mobility unit, the wearer cannot adjust the CCA even if the headphones or microphones have shifted, for example. Shifting of the CCA can be a safety hazard if the CCA rotates over the face of the wearer while in the suit. In addition, because the CCA is worn on the head, it must be sized for each wearer and is susceptible to degradation due to sweat. The CCA can interfere with in-helmet mechanisms, such as the straw from the in-suit drink bag (IDB).

Embodiments of the systems and methods detailed herein relate to a microphone integrated into a helmet. Generally, a microphone converts acoustic waves to electrical signals for storage or transmission. According to exemplary embodiments, a portion of the helmet acts as a diaphragm of the microphone that vibrates in response to acoustic waves such that the vibration may be converted to an electrical signal by a transducer. Exemplary applications for the helmet with the integrated microphone according to one or more embodiments include deep space (e.g., in an extravehicular mobility unit or space suit), underwater (e.g., in an atmospheric diving suit), earth-based (e.g., in a hazmat suit or contamination suit), high-altitude (e.g. in a flight suit) and sub-surface applications. Generally, the suit that mates to the helmet is referred to as an atmospheric suit.

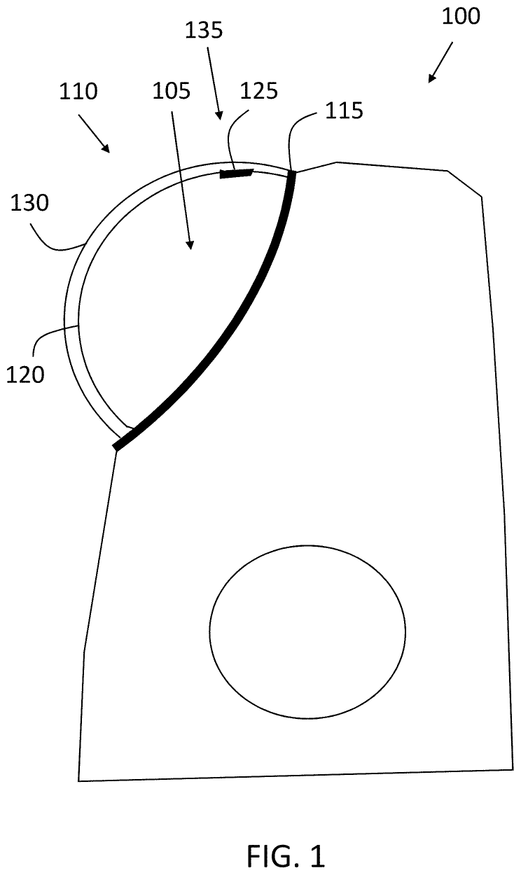

FIG. 1 shows aspects of an atmospheric suit 100 with a microphone 135 integrated into a helmet 110 according to one or more embodiments. As previously noted, the atmospheric suit 100 may be an extravehicular mobility unit used in a deep space application as one example. Alternately, the helmet 110 may be part of a different atmospheric suit 100 employed in underwater, earth-based, high-altitude, or sub-surface applications. The helmet 110 provides a volume 105 to accommodate the head of a wearer of the atmospheric suit 100. The helmet 110 includes an inner bubble 120 that maintains the gasses of the atmospheric suit 100 to create an environment to sustain the wearer. An outer bubble 130 is used to deflect or withstand impact forces, protecting the inner bubble 120.

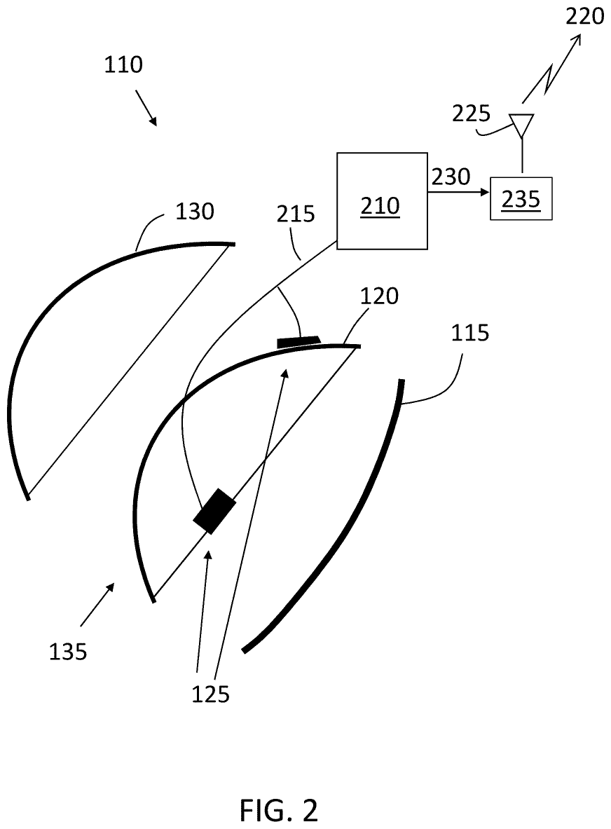

In space suit applications, the inner bubble 120 and the outer bubble 130 are both polycarbonate layers and, as such, are optically transparent. The inner bubble 120 and the outer bubble 130 are mated to the atmospheric suit 100 via a mating ring 115. An exemplary microphone 135 includes a vibration sensor 125 bonded to the surface of the inner bubble 120 in the space between the inner bubble 120 and the outer bubble 130. The vibration sensor 125, which converts the vibration resulting from an acoustic wave into an electrical signal, may include a transducer or a piezoelectric (PE) sensor, for example. The microphone 135 is formed by a combination of the vibration sensor 125 and the inner bubble 120, which functions as a diaphragm. The microphone 135 formed according to one or more embodiments is not susceptible to noise caused by air blowing from circulation fans (e.g., in the space suit). The microphone 135 is further discussed with reference to FIG. 2.

FIG. 2 is an exploded view of a helmet 110 with integrated microphones 135 according to one or more embodiments. The mating ring 115, inner bubble 120, and outer bubble 130 are shown. Two vibration sensors 125 are shown bonded to the outer surface of the inner bubble 120. The vibration sensors 125 transform the sensed vibrations to electrical signals. A wire 215 is shown between processing circuitry 210 and the vibration sensors 125. The wire 215 conveys electrical signals from the vibration sensors 125 to the processing circuitry 210. In alternate embodiments, the vibration sensors 125 may transmit wirelessly to processing circuitry 210.

The processing circuitry 210 conditions and processes the electrical signals from one or more vibration sensors 125 and provides the result as an electrical signal 230 representing the audio to a radio frequency (RF) transmitter 235. An RF signal 220 may be transmitted wirelessly by the RF transmitter 235 via antenna 225. The RF signal 220 may be transmitted to other wearers of atmospheric suits 100, for example. The wires 215, processing circuitry 210, and RF transmitter 235 may be disposed within or outside of the atmospheric suit 100. When the atmospheric suit 100 is filled with oxygen, as in the case of an extravehicular mobility unit, for example, the option to move all electrical components outside the atmospheric suit 100 can improve safety.

In the exemplary case of the vibration sensors 125 including PE sensors, an acoustic wave from the wearer (e.g., voice in the volume 105) causes vibration of the inner bubble 120, which acts as a diaphragm. This vibration is sensed as a change in pressure or acceleration that is converted to an electrical signal by the PE sensors. The electrical output of the PE sensors is carried over the wires 215 (or transmitted wirelessly) to the processing circuitry 210. The RF transmitter 235 may ultimately transmit an RF signal 220 that acts as a carrier for the audio.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A helmet with an integrated microphone, the helmet comprising:
a first portion configured to attach to a mating ring, wherein the first portion is shaped to create a volume for a head of a wearer;
a second portion configured to attach to the mating ring, wherein the first portion is entirely surrounded by the second portion without being in contact with the second portion and the second portion is farther from the volume than the first portion; and
one or more vibration sensors attached to the first portion, wherein the one or more vibration sensors are configured to output an electrical signal and the microphone is formed by the one or more vibration sensors and the first portion.

2. The helmet according to claim 1, wherein the one or more vibration sensors are bonded to an outer surface of the first portion in a space between the first portion and the second portion.

3. The helmet according to claim 1, further comprising processing circuitry configured to receive the electrical signal from each of the one or more vibration sensors.

4. The helmet according to claim 3, wherein the processing circuitry is configured to provide an output signal to a radio frequency (RF) transmitter, and the RF transmitter is configured to transmit an RF signal resulting from the output signal of the processing circuitry.

5. The helmet according to claim 1, wherein the one or more vibration sensors are transducers or piezoelectric (PE) sensors.

6. The helmet according to claim 1, wherein the one or more vibration sensors is arranged on the first portion to sense vibration in the first portion and generate the electrical signal in response to the vibration.

7. The helmet according to claim 1, wherein the first portion and the second portion include a polycarbonate layer.

8. An atmospheric suit with a microphone integrated into a helmet, the atmospheric suit comprising:
a first portion of the helmet configured to attach to a mating ring of the atmospheric suit, wherein the first portion of the helmet is shaped to create a volume for the head of a wearer and the first portion creates an internal atmosphere of the atmospheric suit when attached to the mating ring;
a second portion of the helmet configured to attach to the mating ring, wherein the first portion of the helmet is entirely surrounded by the second portion of the helmet without being in contact with the second portion of the helmet and the second portion of the helmet is farther from the volume than the first portion of the helmet; and
one or more vibration sensors attached to the first portion of the helmet, wherein the one or more vibration sensors are configured to output an electrical signal and the microphone is formed by the one or more vibration sensors and the first portion of the helmet.

9. The atmospheric suit according to claim 8, wherein the one or more vibration sensors are bonded to an outer surface of the first portion of the helmet in a space between the first portion of the helmet and the second portion of the helmet, and the one or more vibration sensors are transducers or piezoelectric (PE) sensors.

10. The atmospheric suit according to claim 8, further comprising processing circuitry configured to receive the electrical signal from each of the one or more vibration sensors.

11. The atmospheric suit according to claim 10, wherein the processing circuitry is configured to provide an output signal to a radio frequency (RF) transmitter, and the RF transmitter is configured to transmit an RF signal resulting from the output signal of the processing circuitry.

12. The atmospheric suit according to claim 8, wherein the one or more vibration sensors is arranged on the first portion of the helmet to sense vibration in the first portion of the helmet and generate the electrical signal in response to the vibration.

13. The atmospheric suit according to claim 8, wherein the first portion of the helmet and the second portion of the helmet include a polycarbonate layer.

14. A method of assembling a microphone, the method comprising:
attaching one or more vibration sensors to a first portion of a helmet, wherein the one or more vibration sensors are configured to provide an electrical signal;
attaching the first portion of the helmet to a mating ring to create a volume for a head of a wearer of the helmet; and
attaching a second portion of the helmet to the mating ring such that the first portion of the helmet is entirely surrounded by the second portion of the helmet without being in contact with the second portion of the helmet, wherein the second portion of the helmet is farther from the volume than the first portion of the helmet.

15. The method according to claim 14, wherein the attaching the one or more vibration sensors to the first portion of the helmet includes bonding the one or more vibration sensors to an outer surface of the first portion of the helmet in a space between the first portion of the helmet and the second portion of the helmet.

16. The method according to claim 14, further comprising arranging processing circuitry to receive the electrical signal from each of the one or more vibration sensors.

17. The method according to claim 16, further comprising configuring the processing circuitry to provide an output signal to a radio frequency (RF) transmitter and configuring the RF transmitter to transmit an RF signal resulting from the output signal of the processing circuitry.

18. The method according to claim 14, wherein the attaching the one or more vibration sensors includes attaching one or more transducers or piezoelectric (PE) sensors.

19. The method according to claim 14, wherein the attaching the one or more vibration sensors to the first portion of the helmet includes arranging the one or more vibration sensors to sense vibration in the first portion of the helmet and generate the electrical signal in response to the vibration.

20. The method according to claim 14, wherein the first portion of the helmet and the second portion of the helmet include a polycarbonate layer.
